(19) United States
(12) Patent Application Publication
(10) Pub. No.: US 2010/0195628 A1
(43) Pub. Date: Aug. 5, 2010

(54) APPARATUS AND METHOD FOR TIME-DIVISION MULTIPLEXING (TDM) FOR MULTIPLE SIGNAL OFDM SIGNAL FORMATS

(75) Inventors: GORDON K. WALKER, Poway, CA (US); Murali R. Chari, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/696,369

(22) Filed: Jan. 29, 2010

Related U.S. Application Data
(60) Provisional application No. 61/148,969, filed on Feb. 1, 2009.

(51) Int. Cl. H04J 3/00

(52) U.S. Cl. 370/336

(57) ABSTRACT

Methods, systems and apparatus, including computer programs encoded on computer storage media, for operating time division multiplexing (TDM) on segments of MediaFLO superframes comprising: generating a MediaFLO OFDM waveform with at least one MediaFLO frame; allocating a MediaFLO local multiplex time segment in the at least one MediaFLO frame for non-MediaFLO data; and inserting the non-MediaFLO data into the MediaFLO local multiplex time segment. In one example, the non-MediaFLO data is a DVB-H table that is split into two time segments within the MediaFLO OFDM waveform. In another aspect, the apparatus and method for operating time division multiplexing (TDM) on alternate whole superframes of time comprising generating a MediaFLO OFDM waveform with a plurality of MediaFLO superframes; multiplexing the MediaFLO OFDM waveform with non-MediaFLO data over the plurality of MediaFLO superframes for whole superframe durations; and inserting MediaFLO data in at least one of the plurality of MediaFLO superframes.

### CLAIM OF PRIORITY UNDER 35 U.S.C. & 119

The present Application for Patent claims priority to Provisional Application No. 61/148,969 entitled Method and Apparatus for Time-Division Multiplexing (TDM) for Multiple Signal OFDM Signal Formats filed Feb. 1, 2009, and assigned to the assignee hereof and hereby expressly incorporated by reference herein.

### TECHNICAL FIELD

This disclosure relates generally to apparatus and methods for wireless communications systems using orthogonal frequency division multiplexing (OFDM). In particular, the disclosure relates to employing time division multiplexing (TDM) in orthogonal frequency division multiplexing (OFDM) systems for multiplexing a plurality of different signal formats, including but not limited to, MediaFLO, digital video broadcasting-handheld (DVB-H), digital video broadcasting-satellite services to handhelds (DVB-SH), digital video broadcasting-handheld 2 (DVB-H2), China Multimedia Mobile Broadcasting (CMMB), Advanced Television Systems Committee-Mobile/Handheld (ATSC-M/H), etc.

### BACKGROUND

Wireless communications systems provide various communication services to users that are away from the fixed telecommunications infrastructure or are moving. These wireless systems employ radio frequencies to interconnect mobile user devices with various base stations in the service area. The base stations, in turn, are connected to mobile switching centers which route connections to and from the mobile user devices to others on various communications networks such as the public switched telephony network (PSTN), Internet, etc. In this manner, users that are geographically separated from fixed sites may receive communication services such as voice telephony, paging, messaging, email, data transfers, video, Web browsing, etc.

Due to the use of radio frequencies for wireless interconnection which can be received by all parties, all mobile users must agree on a common set of protocols to share the scarce radio spectrum allocated for wireless communication services. One important protocol relates to the access method used to connect a mobile user device to the wireless communications network. Various access methods include frequency division multiple access (FDMA), time division multiple access (TDMA), code division multiple access (CDMA), and orthogonal frequency division multiplex (OFDM). OFDM is increasingly popular in terrestrial wireless communication systems because its format facilitates the mitigation of multipath distortions which are incurred in wireless propagation. OFDM utilizes a plurality of carriers harmonically spaced in the frequency domain such that data modulated on each carrier is orthogonal to the others. OFDM may be efficiently modulated and demodulated by using Fast Fourier Transform (FFT) techniques in both the transmitter and receiver for multiplexing and demultiplexing, respectively.

The international wireless multicasting standard Digital Video Broadcasting-Handheld (DVB-H), derived from Digital Video Broadcasting-Terrestrial (DVB-T), employs a physical layer based on OFDM. In one aspect, DVB-H is designed especially for data broadcasting to small, energy-constrained handheld user devices. DVB-H employs, for example, a technique known as time-slicing, which sends data in short time bursts at a higher instantaneous data rate to conserve battery energy.

In one aspect, the next burst containing new broadcasted data is signaled using a delta-t indicator within the current burst.

In addition, a newer multicasting standard, known as MediaFLO (Forward Link Only) also employs OFDM, but with a much higher data capacity than DVB-H. In one example, wireless system operators that are currently using DVB-H may desire to upgrade their capacity by simultaneously deploying a network based on MediaFLO. However, since spectral resources are limited and highly regulated, a given wireless system operator may have only one frequency allocation available for all its services. Therefore, operators seek methods to share their limited frequency allocations among their various services, such as DVB-H and MediaFLO, which are compatible with existing mobile user devices.

As wireless carriers upgrade the performance of DVB-H systems with MediaFLO they may have a number of potential options. In one example, they may dual carry the content on separate frequencies, until the quantity of single mode handsets is small, and then discontinue service in the old format, and transition service to the new format. This can often entail the use of two separate frequencies during the transition, which is some cases may not be available.

### SUMMARY

Disclosed is an apparatus and method for employing time division multiplexing (TDM) in orthogonal frequency division multiplexing (OFDM) systems for multiplexing different signal formats. According to one aspect, a method for operating time division multiplexing (TDM) on segments of MediaFLO superframes includes generating a MediaFLO OFDM waveform with at least one MediaFLO superframe; allocating a MediaFLO local multiplex time segment in the at least one MediaFLO superframe for non-MediaFLO data; and inserting the non-MediaFLO data into the MediaFLO local multiplex time segment.

According to one aspect, a method for operating time division multiplexing (TDM) on alternate whole superframes of time includes generating a MediaFLO OFDM waveform with a plurality of MediaFLO superframes; multiplexing the MediaFLO OFDM waveform with non-MediaFLO data over the plurality of MediaFLO superframes for whole superframe durations; and inserting MediaFLO data into at least one of the plurality of MediaFLO superframes.

According to one aspect, an apparatus for operating time division multiplexing (TDM) on segments of MediaFLO superframes, the apparatus includes a processor and a memory containing program code executable by the processor for performing the following: generating a MediaFLO OFDM waveform with at least one MediaFLO superframe; allocating a MediaFLO local multiplex time segment in the at least one MediaFLO superframe for non-MediaFLO data; and inserting the non-MediaFLO data into the MediaFLO local multiplex time segment.

According to one aspect, an apparatus for operating time division multiplexing (TDM) on alternate whole superframes of time, the apparatus includes a processor and a memory containing program code executable by the processor for performing the following: generating a MediaFLO OFDM waveform with a plurality of MediaFLO superframes; multiplexing the MediaFLO OFDM waveform with non-MediaFLO data over the plurality of MediaFLO superframes for whole superframe durations; and inserting MediaFLO data into at least one of the plurality of MediaFLO superframes.

According to one aspect, an apparatus for operating time division multiplexing (TDM) on segments of MediaFLO superframes includes means for generating a MediaFLO OFDM waveform with at least one MediaFLO superframe; means for allocating a MediaFLO local multiplex time segment in the at least one MediaFLO superframe for non-MediaFLO data; and means for inserting the non-MediaFLO data into the MediaFLO local multiplex time segment.

According to one aspect, an apparatus for operating time division multiplexing (TDM) on alternate whole superframes of time includes means for generating a MediaFLO OFDM waveform with a plurality of MediaFLO superframes; means for multiplexing the MediaFLO OFDM waveform with non-MediaFLO data over the plurality of MediaFLO superframes for whole superframe durations; and means for inserting MediaFLO data into at least one of the plurality of MediaFLO superframes.

According to one aspect, a computer-readable medium storing a computer program, wherein execution of the computer program is for: generating a MediaFLO OFDM waveform with at least one MediaFLO superframe; allocating a MediaFLO local multiplex time segment in the at least one MediaFLO superframe for DVB-H data; and inserting the non-MediaFLO data into the MediaFLO local multiplex time segment.

According to one aspect, a computer-readable medium storing a computer program, wherein execution of the computer program is for: generating a MediaFLO OFDM waveform with a plurality of MediaFLO superframes; multiplexing the MediaFLO OFDM waveform with non-MediaFLO data over the plurality of MediaFLO superframes for whole superframe durations; and inserting MediaFLO data into at least one of the plurality of MediaFLO superframes.

Some deployed networks utilize DVB-H and other variants of OFDM multicast technology as well as include an upgraded capacity with the introduction of a second mode. A potential advantage of the present disclosure includes the ability to operate both systems in a concurrent fashion in a single frequency allocation. And, other advantages will become readily apparent from the context of the present disclosure.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 is a block diagram illustrating an example of a wireless communication system.

FIG. 2 illustrates an example of a wireless communications system that supports a plurality of user devices.

FIG. 3 illustrates an example of time division multiplexing (TDM) of two wireless formats within the same frequency allocation.

FIG. 4 illustrates an example of time division multiplexing (TDM) of DVB-H and MediaFLO operating on alternate whole superframes of system time.

FIG. 5 illustrates an example of DVB-H time slicing for adjacent markets.

FIG. 6 illustrates an example of time slicing applied to handover and TDM of FLO and DVB-H.

FIG. 7 illustrates an example flow diagram for operating time division multiplexing (TDM) on segments of MediaFLO frames.

FIG. 8 illustrates an example flow diagram for operating time division multiplexing (TDM) on alternate whole superframes of time.

FIG. 9 illustrates an example of a MediaFLO superframe structure.

FIG. 10 illustrates an example of a device comprising a processor in communication with a memory for either executing the processes for operating time division multiplexing (TDM) on segments of MediaFLO frames or executing the processes for operating time division multiplexing (TDM) on alternate whole superframes of time.

FIG. 11 illustrates an example of a device comprising a processor in communication with a memory for executing the processes for operating time division multiplexing (TDM) on segments of MediaFLO frames.

FIG. 12 illustrates an example of a device suitable for operating time division multiplexing (TDM) on segments of MediaFLO frames.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). Cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). Cdma2000 is described in documents from an organization named “3rd Generation Partnership Project 2” (3GPP2). These various radio technologies and standards are known in the art.

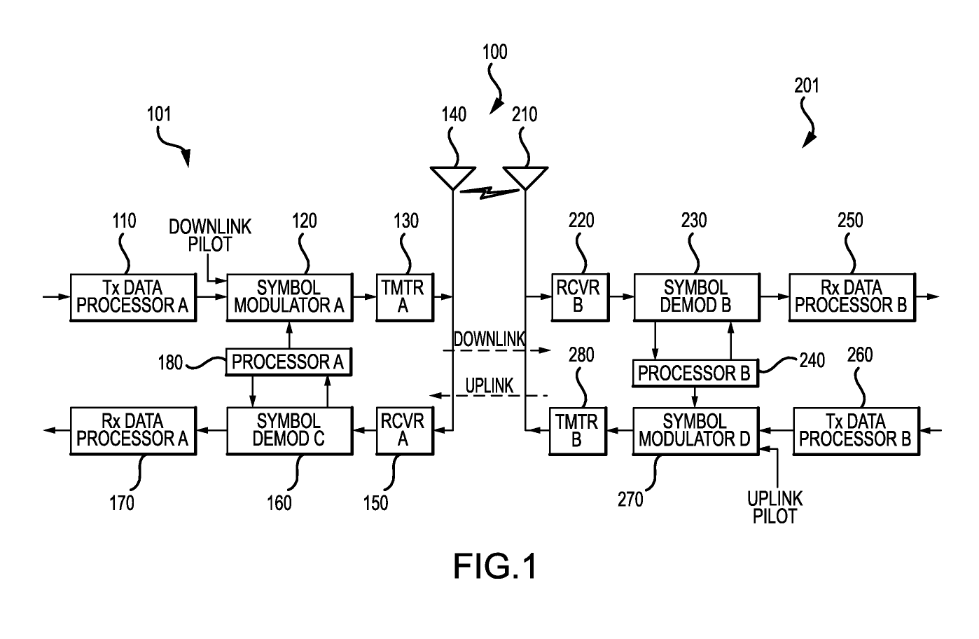

FIG. 1 is a block diagram illustrating an example of a two terminal system 100. One skilled in the art would understand that the example two terminal system 100 illustrated in FIG. 1 may be implemented in an FDMA environment, an OFDMA environment, a CDMA environment, a WCDMA environment, a TDMA environment, a SDMA environment or any other suitable wireless environment.

In one aspect, the two terminal system 100 includes an access node 101 (e.g., base station or Node B) and a user equipment or UE 201 (e.g., user device). In the downlink leg, the access node 101 (e.g., base station or Node B) includes a transmit (TX) data processor A 110 that accepts, formats, codes, interleaves and modulates (or symbol maps) traffic data and provides modulation symbols (e.g., data symbols). The TX data processor A 110 is in communication with a symbol modulator A 120. The symbol modulator A 120 accepts and processes the data symbols and downlink pilot symbols and provides a stream of symbols. In one aspect, it is the symbol modulator A 120 that modulates (or symbol maps) traffic data and provides modulation symbols (e.g., data symbols). In one aspect, symbol modulator A 120 is in communication with processor A 180 which provides configuration information. Symbol modulator A 120 is in communication with a transmitter unit (TMTR) A 130. The symbol modulator A 120 multiplexes the data symbols and downlink pilot symbols and provides them to the transmitter unit A 130.

Each symbol to be transmitted may be a data symbol, a downlink pilot symbol or a signal value of zero. The downlink pilot symbols may be sent continuously in each symbol period. In one aspect, the downlink pilot symbols are frequency division multiplexed (FDM). In another aspect, the downlink pilot symbols are orthogonal frequency division multiplexed (OFDM). In yet another aspect, the downlink pilot symbols are code division multiplexed (CDM). In one aspect, the transmitter unit A 130 receives and converts the stream of symbols into one or more analog signals and further conditions, for example, amplifies, filters and/or frequency upconverts the analog signals, to generate an analog downlink signal suitable for wireless transmission. The analog downlink signal is then transmitted through antenna 140.

In the downlink leg, the UE 201 (e.g., user device) includes antenna 210 for receiving the analog downlink signal and inputting the analog downlink signal to a receiver unit (RCVR) B 220. In one aspect, the receiver unit B 220 conditions, for example, filters, amplifies, and frequency downconverts the analog downlink signal to a first “conditioned” signal. The first “conditioned” signal is then sampled. The receiver unit B 220 is in communication with a symbol demodulator B 230. The symbol demodulator B 230 demodulates the first “conditioned” and “sampled” signal (e.g., data symbols) outputted from the receiver unit B 220. One skilled in the art would understand that an alternative is to implement the sampling process in the symbol demodulator B 230. The symbol demodulator B 230 is in communication with a processor B 240. Processor B 240 receives downlink pilot symbols from symbol demodulator B 230 and performs channel estimation on the downlink pilot symbols. In one aspect, the channel estimation is the process of characterizing the current propagation environment. The symbol demodulator B 230 receives a frequency response estimate for the downlink leg from processor B 240. The symbol demodulator B 230 performs data demodulation on the data symbols to obtain data symbol estimates on the downlink path. The data symbol estimates on the downlink path are estimates of the data symbols that were transmitted. The symbol demodulator B 230 is also in communication with a RX data processor B 250.

The RX data processor B 250 receives the data symbol estimates on the downlink path from the symbol demodulator B 230 and, for example, demodulates (i.e., symbol demaps), deinterleaves and/or decodes the data symbol estimates on the downlink path to recover the traffic data. In one aspect, the processing by the symbol demodulator B 230 and the RX data processor B 250 is complementary to the processing by the symbol modulator A 120 and TX data processor A 110, respectively.

In the uplink leg, the UE 201 (e.g., user device) includes a TX data processor B 260. The TX data processor B 260 accepts and processes traffic data to output data symbols. The TX data processor B 260 is in communication with a symbol modulator D 270. The symbol modulator D 270 accepts and multiplexes the data symbols with uplink pilot symbols, performs modulation and provides a stream of symbols. In one aspect, symbol modulator D 270 is in communication with processor B 240 which provides configuration information. The symbol modulator D 270 is in communication with a transmitter unit B 280.

Each symbol to be transmitted may be a data symbol, an uplink pilot symbol or a signal value of zero. The uplink pilot symbols may be sent continuously in each symbol period. In one aspect, the uplink pilot symbols are frequency division multiplexed (FDM). In another aspect, the uplink pilot symbols are orthogonal frequency division multiplexed (OFDM). In yet another aspect, the uplink pilot symbols are code division multiplexed (CDM). In one aspect, the transmitter unit B 280 receives and converts the stream of symbols into one or more analog signals and further conditions, for example, amplifies, filters and/or frequency upconverts the analog signals, to generate an analog uplink signal suitable for wireless transmission. The analog uplink signal is then transmitted through antenna 210.

The analog uplink signal from UE 201 (e.g., user device) is received by antenna 140 and processed by a receiver unit A 150 to obtain samples. In one aspect, the receiver unit A 150 conditions, for example, filters, amplifies and frequency downconverts the analog uplink signal to a second “conditioned” signal. The second “conditioned” signal is then sampled. The receiver unit A 150 is in communication with a symbol demodulator C 160. One skilled in the art would understand that an alternative is to implement the sampling process in the symbol demodulator C 160. The symbol demodulator C 160 performs data demodulation on the data symbols to obtain data symbol estimates on the uplink path and then provides the uplink pilot symbols and the data symbol estimates on the uplink path to the RX data processor A 170. The data symbol estimates on the uplink path are estimates of the data symbols that were transmitted. The RX data processor A 170 processes the data symbol estimates on the uplink path to recover the traffic data transmitted by the wireless communication device 201. The symbol demodulator C 160 is also in communication with processor A 180. Processor A 180 performs channel estimation for each active terminal transmitting on the uplink leg. In one aspect, multiple terminals may transmit pilot symbols concurrently on the uplink leg on their respective assigned sets of pilot subbands where the pilot subband sets may be interlaced.

Processor A 180 and processor B 240 can direct (i.e., control, coordinate or manage, etc.) operation at the access node 101 (e.g., base station or Node B) and at the UE 201 (e.g., user device), respectively. In one aspect, either or both processor A 180 and processor B 240 are associated with one or more memory units (not shown) for storing of program codes and/or data. In one aspect, either or both processor A 180 or processor B 240 perform computations to derive frequency and impulse response estimates for the uplink leg and downlink leg, respectively.

In one aspect, the two terminal system 100 is a multiple-access system. For a multiple-access system (e.g., frequency division multiple access (FDMA), orthogonal frequency division multiple access (OFDMA), code division multiple access (CDMA), time division multiple access (TDMA), space division multiple access (SDMA), etc.), multiple terminals transmit concurrently on the uplink leg, allowing access to a plurality of UEs (e.g., user devices). In one aspect, for the multiple-access system, the pilot subbands may be shared among different terminals. Channel estimation techniques are used in cases where the pilot subbands for each terminal span the entire operating band (possibly except for the band edges). Such a pilot subband structure may be desirable to obtain frequency diversity for each terminal.

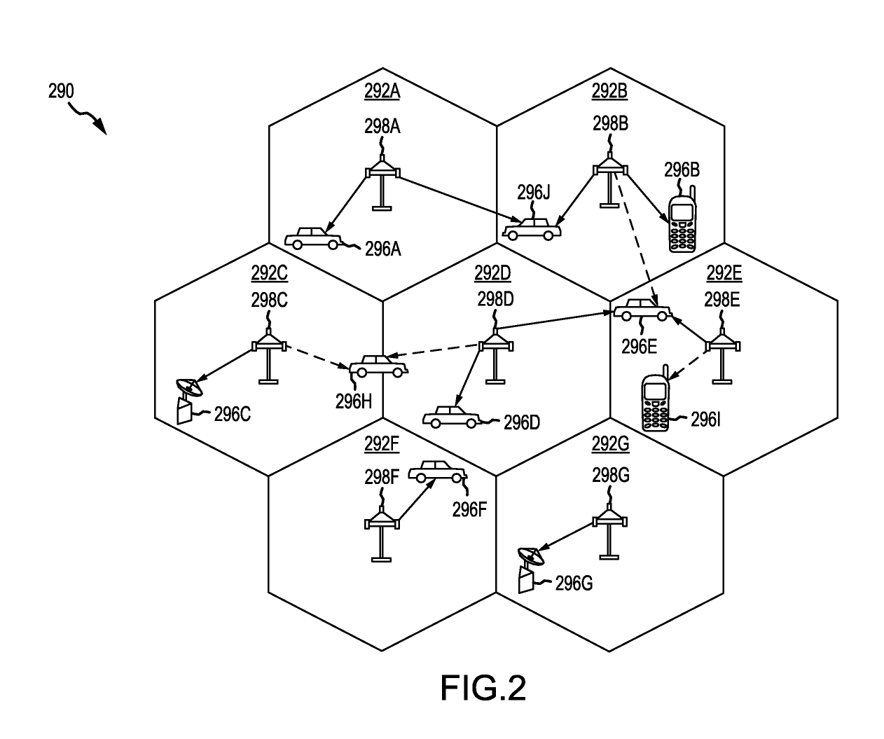

FIG. 2 illustrates an example of a wireless communications system 290 that supports a plurality of user devices. In FIG. 2, reference numerals 292A to 292G refer to cells, reference numerals 298A to 298G refer to base stations (BS) or node Bs and reference numerals 296A to 296J refer to access user devices (a.k.a. user equipments (UE)). Cell size may vary. Any of a variety of algorithms and methods may be used to schedule transmissions in system 290. System 290 provides communication for a number of cells 292A through 292G, each of which can be serviced by a corresponding base station 298A through 298G, respectively.

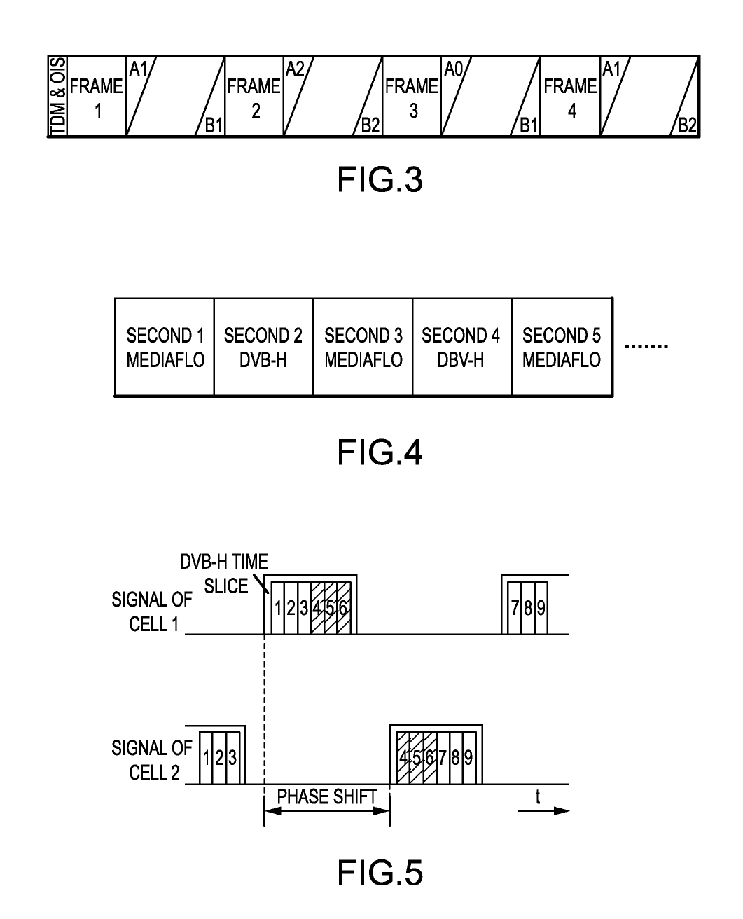

FIG. 3 illustrates an example of time division multiplexing (TDM) of two wireless formats within the same frequency allocation. In particular, FIG. 3 illustrates an example of time division multiplexing of multiple multimedia waveforms operating on fractions of MediaFLO frames. In one example, TDM can be accomplished by nominally replacing the local multiplex of MediaFLO or a similar multicasting service by the legacy DVB-H format. In one aspect, the local multiplex of MediaFLO is a portion of the broadcasted signal allocated for local area services. For example, in DVB-H the TDM mechanism is accomplished by placing a DVB-H table or tables in the portion of the MediaFLO waveform where the local multiplex would normally be carried. For example, the duration of the DVB transmission is scaled to fit the section of MediaFLO waveform made available. The DVB-H tables are likely, for example, 256 rows at low bit rates.

In one aspect, the present disclosure relates to employing time division multiplexing (TDM) in orthogonal frequency division multiplexing (OFDM) systems for multiplexing a plurality of different signal formats with a known or specified on times, including but not limited to, MediaFLO, digital video broadcasting-handheld (DVB-H), digital video broadcasting-satellite services to handhelds (DVB-SH), digital video broadcasting-handheld 2 (DVB-H2), China Multimedia Mobile Broadcasting (CMMB), Advanced Television Systems Committee-Mobile/Handheld (ATSC-M/H), etc. The references to DVB-H in the present disclosure are examples and should not be construed as limiting to the DVB-H example. One skilled in the art would also understand that the examples listed here regarding the different signal formats are not exclusive and others may be applicable without limiting the spirit or scope of the present disclosure.

In one aspect, there are two potential methods of dealing with the ramp in and ramp out of the DVB-T interleaver depicted in FIG. 3. The first of these is based on time segments A1 and B1 being a single DVB-H table with their distribution split in time. In one example, the table size is constructed specifically to consume the time comprised in filling and emptying the convolutional interleaver of the DVB-T receiver. The convolutional interleaver may be filled with null packets for the highest level of backward compatibility with existing DVB-H receivers, although the data rate may be high enough to allow their use for service delivery. The configuration shown can be the minimum usable table duration, and in an example, the transition table could be of longer duration.

An example of a second method is illustrated around frame 4 in FIG. 3. In this method the two ramp in and ramp out sequences are immediately before and after a MediaFLO frame of data. In some implementations, splitting a table across two time slices is nominally not allowed in DVB-H.

In one aspect, the DVB-H standard includes broadcasting of a robust signaling channel known as Transmission Parameter Signaling (TPS). For example, TPS can be used to convey the status of time-slicing and the optional multiprotocol encapsulated forward error correction (MPE-FEC). In one example, TPS detection requires up to 80 msec in a DVB-H system. In one aspect, the DVB-H receiver can acquire TPS during the data burst and apply the result to the next DVB-H burst received.

FIG. 4 illustrates an example of time division multiplexing (TDM) of DVB-H and MediaFLO operating on alternate whole superframes of system time. In an alternate example, illustrated in FIG. 4, MediaFLO is allowed to operate on alternate whole superframes of system time. In this example, modifications to the MediaFLO encoder and decoder may be applied to allow it to place two or more seconds of media in a single superframe.

In one aspect, the MediaFLO receiver is configured to interpret that the MediaFLO version only uses, e.g., alternate or every third superframe, rather than every second. This is realizable, since the MediaFLO or other replacement system can be being deployed after the legacy, or incumbent, system. There are many options with respect to the assigning of active MediaFLO seconds. For example, a “one of N” method is one assignment option.

In another aspect, the TDM method may have potential handover advantages in a multiple frequency network (MFN) deployment. FIG. 5 illustrates an example of DVB-H time slicing for adjacent user markets. As illustrated in FIG. 5, time shifting time slots is a technique for allocating DVB-H time slots relative to adjacent user markets. In one example, access to the desired media in the adjacent market is assured by time offset. This basic access mechanism can be adapted to the TDM application of MediaFLO and DVB-H.

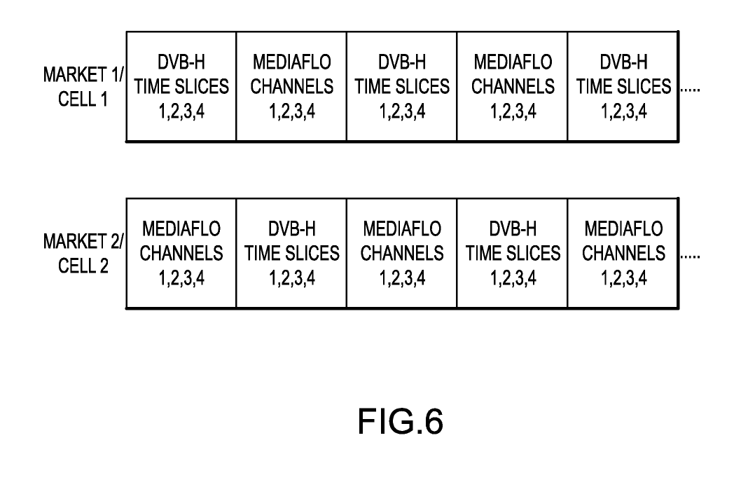

For example, FIG. 6 illustrates an example of time slicing applied to handover and TDM of MediaFLO and DVB-H. In this example, MediaFLO channels and DVB-H time slices are alternated between adjacent time slots for two distinct user markets covered by two cells.

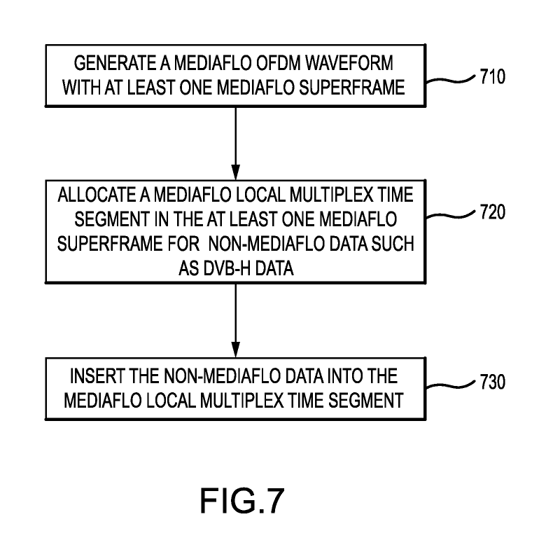

FIG. 7 illustrates an example flow diagram for operating time division multiplexing (TDM) on segments of MediaFLO superframes. In block 710, generate a MediaFLO OFDM waveform with at least one MediaFLO superframe. In block 720, allocate a MediaFLO local multiplex time segment in the at least one MediaFLO superframe for non-MediaFLO data (such as DVB-H data). In block 730, insert the non-MediaFLO data into the MediaFLO local multiplex time segment. In one example, the non-MediaFLO data are a DVB-H table that is split into two time segments within the MediaFLO OFDM waveform. In one example, the steps in the flow diagram of FIG. 7 are performed by a transmitter.

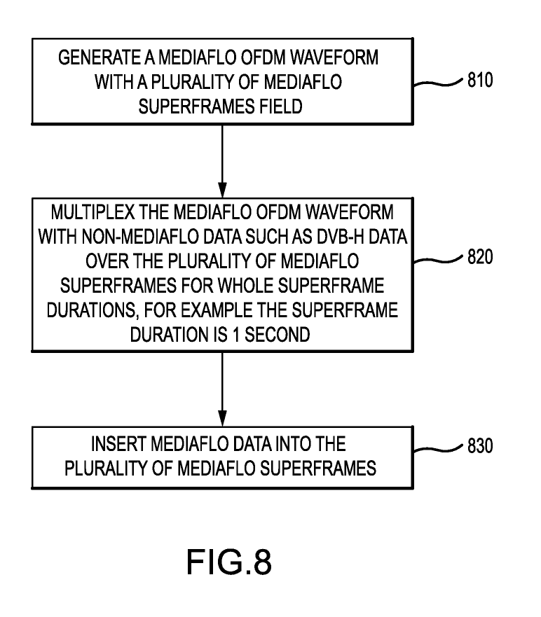

FIG. 8 illustrates an example flow diagram for operating time division multiplexing (TDM) on alternate whole superframes of time. In block 810, generate a MediaFLO OFDM waveform with a plurality of MediaFLO superframes. In block 820, multiplex the MediaFLO OFDM waveform with non-MediaFLO data (such as DVB-H data) over the plurality of MediaFLO superframes for whole superframe durations, for example the superframe duration is a 1 second. In block 830, insert MediaFLO data into the plurality of MediaFLO superframes.

In one aspect, the non-MediaFLO data is one of the following: digital video broadcasting-handheld (DVB-H) data, digital video broadcasting-satellite services to handhelds (DVB-SH) data, digital video broadcasting-handheld 2 (DVB-H2) data, China Multimedia Mobile Broadcasting (CMMB) data, or Advanced Television Systems Committee-Mobile/Handheld (ATSC-M/H) data. One skilled in the art would understand that these examples are not exclusive and that other examples may be applicable without affecting the spirit or scope of the present disclosure.

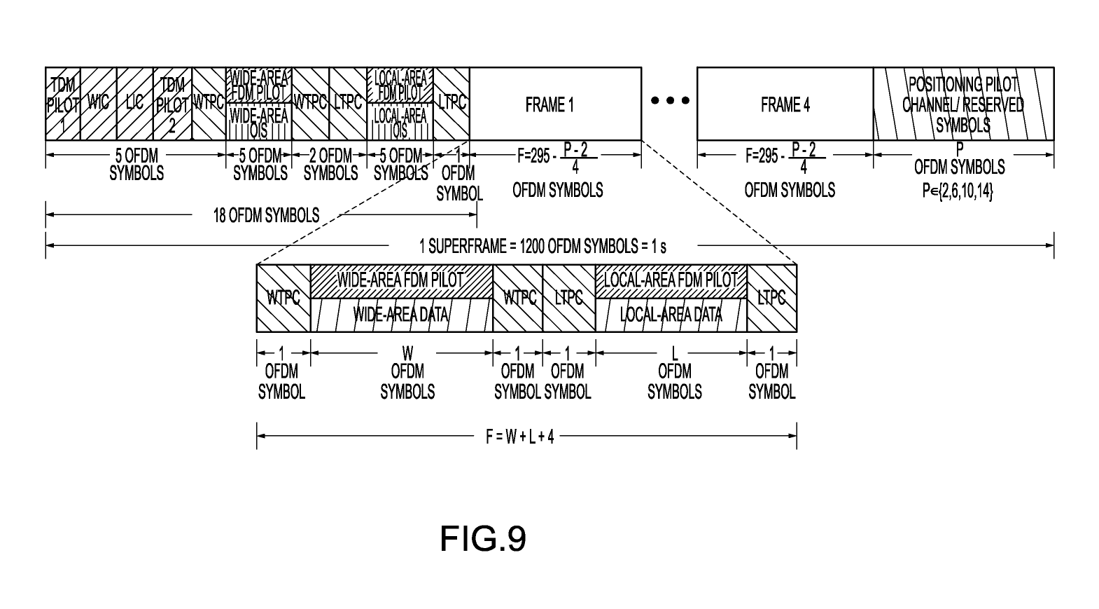

FIG. 9 illustrates an example of a MediaFLO superframe structure. In one aspect, transmitted data are formatted as superframes, each with a duration of 1 second. In one example, a superframe is partitioned into four portions: TDM pilots, overhead information symbols (OIS), data frames, and a positioning pilot channel (PPC). Data frames can include user information for both wide area and local area services.

The methods and means to operate two nominally incompatible multimedia formats by the use of time division multiplexing have been disclosed herein. The example flow diagram of FIG. 7 represents a disclosure with the capability of fine granularity in the allocation of bit rate between the two formats. The example flow diagram of FIG. 7 can operate on fractions of MediaFLO frames. The example flow diagram of FIG. 8 comprises operating MediaFLO on only specified whole superframe durations for a finite period of time.

The present disclosure allows for the construction and operation of a hybrid MediaFLO/DVB-H transmission system for use during transition periods in existing DVB-H networks. These present disclosure allows for the construction and operation of a hybrid MediaFLO/DVB-H transmission system for use during transition periods in existing DVB-H networks. The present disclosure has been described in the context of transition to MediaFLO from DVB-H. However, one skilled in the art would understand that the methods disclosed herein can be generalized to be applied to the transition between other OFDM formats that utilize TDM in one manner or another without affecting the spirit or scope of the present disclosure.

Additional features of the present disclosure can include, but are not limited to, the following: a) supporting two dissimilar multicast multimedia formats within a single frequency allocation, by using time division multiplexing; b) filling and emptying (i.e., interleaving) the convolution DVB-T interleaver either wrapping around a table or group of tables or spanning the off time of the DVB-H receiver; c) an apparatus comprising a transmitter synchronized to GPS or other synchronous time that nominally first generates a MediaFLO waveform that does not completely fill each second (superframe), and then constructs DVB-H signal format to complete the each fraction of a second left open by MediaFLO; d) a method for which a MediaFLO transmitter operates on only some fraction of the system whole seconds reserving the balance of the whole seconds for DVB-H operations; e) a communications method that identifies which superframes (GPS whole seconds) are MediaFLO waveform, and communicates this to MediaFLO receivers; f) an operational method in which the MediaFLO portion of the transmitter does not reference specific regions of time frequency space (e.g., MediaFLO logical channel (MLC)) and wherein the portion of time that is occupied by DVB-H is not referenced; and g) a method in which the DVB-H portion of the waveform does not reference regions of time that do not contain the DVB-H waveform.

Additionally, receivers may be constructed that listen to both portions of the waveform. In one aspect, the guide of the later (e.g., next generation) system may reference the content of both formats. And, the older (lower capacity) format may not need to reference any content carried in the newer waveform.

One skilled in the art would understand that the steps disclosed in the example flow diagrams in FIGS. 7 and 8 can be interchanged in their order without departing from the scope and spirit of the present disclosure. Also, one skilled in the art would understand that the steps illustrated in the flow diagrams are not exclusive and other steps may be included or one or more of the steps in the example flow diagrams may be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any non-transitory computer-readable medium known in the art or implemented in any computer program product known in the art.

In one or more examples, the steps or functions described herein may be implemented in hardware, software, firmware, or any combination thereof If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above can also be included within the scope of computer-readable media. Additionally, the operations of a method or algorithm may reside as one or any combination or set of codes and instructions on a machine readable medium and computer-readable medium, which may be incorporated into a computer program product.

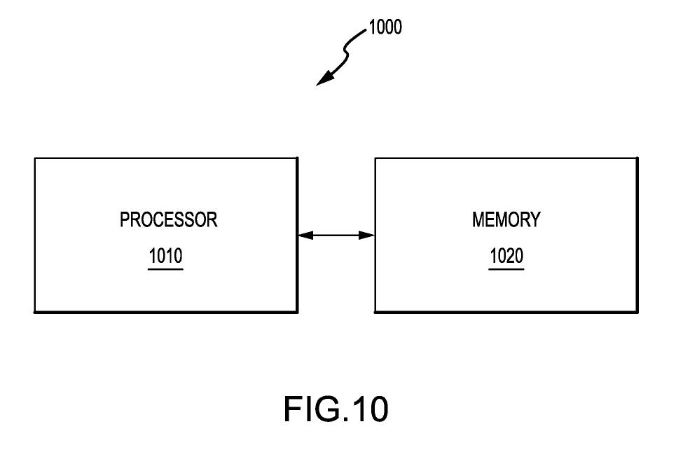

In one example, the illustrative components, flow diagrams, logical blocks, modules and/or algorithm steps described herein are implemented or performed with one or more processors. In one aspect, a processor is coupled with a memory which stores data, metadata, program instructions, etc., to be executed by the processor for implementing or performing the various flow diagrams, logical blocks and/or modules described herein. FIG. 10 illustrates an example of a device 1000 comprising a processor 1010 in communication with a memory 1020 for executing the processes for operating time division multiplexing (TDM) on segments of MediaFLO frames. In one example, the device 1000 is used to implement the algorithm illustrated in FIG. 7. In another aspect, the example device 1000 is used for executing the processes for operating time division multiplexing (TDM) on alternate whole superframes of time. In one example, the device 1000 is used to implement the algorithm illustrated in FIG. 8.

In one aspect, the memory 1020 is located within the processor 1010. In another aspect, the memory 1020 is external to the processor 1010. In one aspect, the processor includes circuitry for implementing or performing the various flow diagrams, logical blocks and/or modules described herein.

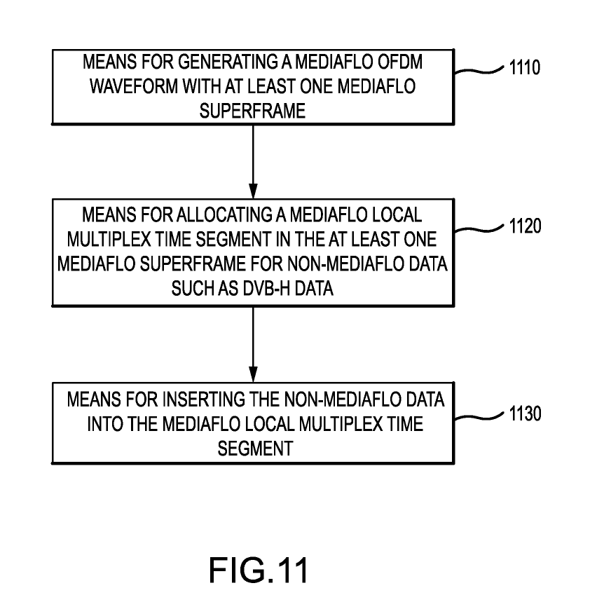

FIG. 11 illustrates an example of a device 1100 suitable for operating time division multiplexing (TDM) on segments of MediaFLO frames. In one aspect, the device 1100 can be implemented by at least one processor comprising one or more modules configured to provide different aspects of operating time division multiplexing (TDM) on segments of MediaFLO frames as described herein in blocks 1110, 1120 and 1130. For example, each module comprises hardware, firmware, software, or any combination thereof. In one aspect, the device 1100 also can be implemented by at least one memory in communication with the at least one processor.

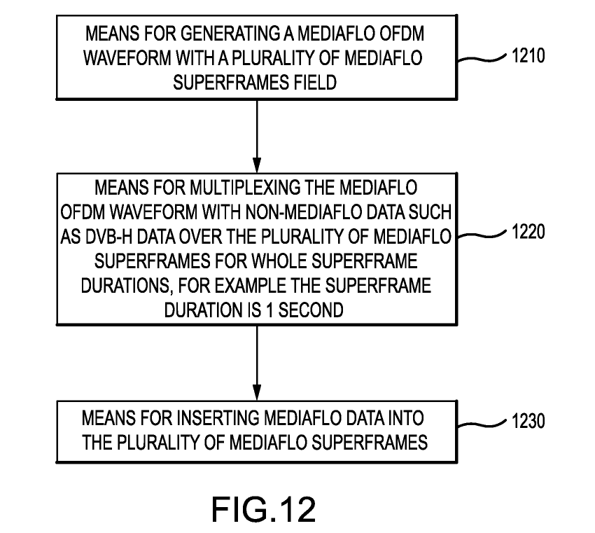

FIG. 12 illustrates an example of a device 1200 suitable for operating time division multiplexing (TDM) on alternate whole superframes of time. In one aspect, the device 1200 can be implemented by at least one processor comprising one or more modules configured to provide different aspects of operating time division multiplexing (TDM) on alternate whole superframes of time as described herein in blocks 1210, 1220 and 1230. For example, each module comprises hardware, firmware, software, or any combination thereof In one aspect, the device 1200 also can be implemented by at least one memory in communication with the at least one processor.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for operating time division multiplexing (TDM) on segments of MediaFLO superframes comprising:
generating a MediaFLO OFDM waveform with at least one MediaFLO superframe;
allocating a MediaFLO local multiplex time segment in the at least one MediaFLO superframe for non-MediaFLO data; and
inserting the non-MediaFLO data into the MediaFLO local multiplex time segment.

2. The method of claim 1, wherein the non-MediaFLO data is one of the following second mobile multimedia formats: digital video broadcasting-handheld (DVB-H) data, digital video broadcasting-satellite services to handhelds (DVB-SH) data, digital video broadcasting-handheld 2 (DVB-H2) data, China Multimedia Mobile Broadcasting (CMMB) data, or Advanced Television Systems Committee-Mobile/Handheld (ATSC-M/H) data.

3. The method of claim 1, wherein the non-MediaFLO data is a DVB-H table or a plurality of tables.

4. The method of claim 1, further comprising synchronizing to a GPS synchronous time that is used to generate the MediaFLO waveform, wherein the MediaFLO waveform does not completely fill each alternative superframe.

5. The method of claim 2, further comprising constructing a second mobile multimedia format to complete the allocation of the MediaFLO waveform.

6. The method of claim 2, further comprising operating the balance of the MediaFLO waveform with MediaFLO data for MediaFLO services.

7. The method of claim 6, wherein the balance of the MediaFLO waveform operating MediaFLO services does not reference specific regions of time frequency space.

8. The method of claim 7, wherein the specific regions of time frequency space that are not referenced in a MediaFLO system contain a second mobile multimedia format.

9. The method of claim 6, wherein the balance of the MediaFLO waveform not operating MediaFLO services does not reference specific regions of time frequency space.

10. The method of claim 6, wherein a portion of the MediaFLO waveform containing a second mobile multimedia format data does not reference regions of time that do not contain the second mobile multimedia signal format's data.

11. A method for operating time division multiplexing (TDM) on alternate whole superframes of time comprising:
generating a MediaFLO OFDM waveform with a plurality of MediaFLO superframes;
multiplexing the MediaFLO OFDM waveform with non-MediaFLO data over the plurality of MediaFLO superframes for whole superframe durations; and
inserting MediaFLO data into at least one of the plurality of MediaFLO superframes.

12. The method of claim 11, wherein the non-MediaFLO data is one of the following mobile multimedia formats: digital video broadcasting-handheld (DVB-H) data, digital video broadcasting-satellite services to handhelds (DVB-SH) data, digital video broadcasting-handheld 2 (DVB-H2) data, China Multimedia Mobile Broadcasting (CMMB) data, or Advanced Television Systems Committee-Mobile/Handheld (ATSC-M/H) data.

13. The method of claim 12, wherein the whole superframe durations of the second mobile multimedia format are one second.

14. The method of claim 11, further comprising identifying which of the plurality of MediaFLO superframes include the MediaFLO data.

15. The method of claim 14, further comprising communicating the plurality of MediaFLO superframes that include the MediaFLO data to a MediaFLO receiver.

16. The method of claim 12, further comprising identifying which of the plurality of MediaFLO superframes include a second mobile multimedia format data.

17. The method of claim 16, further comprising communicating the plurality of MediaFLO superframes that include the second mobile multimedia format data to a MediaFLO receiver.

18. The method of claim 12, wherein the balance of the MediaFLO waveform not operating MediaFLO services does not reference specific regions of time frequency space.

19. The method of claim 12, wherein a portion of the MediaFLO waveform containing a second mobile multimedia format's data does not reference regions of time that do not contain the second mobile multimedia format's data.

20. An apparatus for operating time division multiplexing (TDM) on segments of MediaFLO superframes, the apparatus comprising a processor and a memory containing program code executable by the processor for performing the following:
generating a MediaFLO OFDM waveform with at least one MediaFLO superframe;
allocating a MediaFLO local multiplex time segment in the at least one MediaFLO superframe for non-MediaFLO data; and
inserting the non-MediaFLO data into the MediaFLO local multiplex time segment.

21. The apparatus of claim 20, wherein the non-MediaFLO data is one of the following second mobile multimedia formats: digital video broadcasting-handheld (DVB-H) data, digital video broadcasting-satellite services to handhelds (DVB-SH) data, digital video broadcasting-handheld 2 (DVB-H2) data, China Multimedia Mobile Broadcasting (CMMB) data, or Advanced Television Systems Committee-Mobile/Handheld (ATSC-M/H) data.

22. The apparatus of claim 20, wherein the non-MediaFLO data is a DVB-H table or a plurality of tables.

23. The apparatus of claim 20, wherein the memory further comprises program code for synchronizing to a GPS synchronous time that is used to generate the MediaFLO waveform, wherein the MediaFLO waveform does not completely fill each alternative superframe.

24. The apparatus of claim 21, wherein the memory further comprises program code for constructing a second mobile multimedia signal format to complete the allocation of the MediaFLO waveform.

25. The apparatus of claim 21, wherein the memory further comprises program code for operating the balance of the MediaFLO waveform with MediaFLO data for MediaFLO services.

26. The apparatus of claim 25, wherein the balance of the MediaFLO waveform operating MediaFLO services does not reference specific regions of time frequency space.

27. The apparatus of claim 26, wherein the specific regions of time frequency space that are not referenced in a MediaFLO system contain a second mobile multimedia format data.

28. The apparatus of claim 25, wherein the balance of the MediaFLO waveform not operating MediaFLO services does not reference specific regions of time frequency space.

29. The apparatus of claim 21, wherein a portion of the MediaFLO waveform containing a second mobile multimedia format data does not reference regions of time that do not contain the second mobile multimedia format's data.

30. An apparatus for operating time division multiplexing (TDM) on alternate whole superframes of time, the apparatus comprising a processor and a memory containing program code executable by the processor for performing the following:
generating a MediaFLO OFDM waveform with a plurality of MediaFLO superframes;
multiplexing the MediaFLO OFDM waveform with non-MediaFLO data over the plurality of MediaFLO superframes for whole superframe durations; and
inserting MediaFLO data into at least one of the plurality of MediaFLO superframes.

31. The apparatus of claim 30, wherein the non-MediaFLO data is one of the following second mobile multimedia formats: digital video broadcasting-handheld (DVB-H) data, digital video broadcasting-satellite services to handhelds (DVB-SH) data, digital video broadcasting-handheld 2 (DVB-H2) data, China Multimedia Mobile Broadcasting (CMMB) data, or Advanced Television Systems Committee-Mobile/Handheld (ATSC-M/H) data.

32. The apparatus of claim 31, wherein the whole superframe durations of the second mobile multimedia format are one second.

33. The apparatus of claim 30, wherein the memory further comprises program code for identifying which of the plurality of MediaFLO superframes include the MediaFLO data.

34. The apparatus of claim 33, wherein the memory further comprises program code for communicating the plurality of MediaFLO superframes that include the MediaFLO data to a MediaFLO receiver.

35. The apparatus of claim 31, wherein the memory further comprises program code for identifying which of the plurality of MediaFLO superframes include a second mobile multimedia format data.

36. The apparatus of claim 35, wherein the memory further comprises program code for communicating the plurality of MediaFLO superframes that include the second mobile multimedia format data to a MediaFLO receiver.

37. The apparatus of claim 31, wherein the balance of the MediaFLO waveform not operating MediaFLO services does not reference specific regions of time frequency space.

38. The apparatus of claim 31, wherein a portion of the MediaFLO waveform containing a second mobile multimedia format data does not reference regions of time that do not contain the second mobile multimedia format's data.

39. An apparatus for operating time division multiplexing (TDM) on segments of MediaFLO superframes comprising:
means for generating a MediaFLO OFDM waveform with at least one MediaFLO superframe;
means for allocating a MediaFLO local multiplex time segment in the at least one MediaFLO superframe for non-MediaFLO data; and
means for inserting the non-MediaFLO data into the MediaFLO local multiplex time segment.

40. The apparatus of claim 39, wherein the non-MediaFLO data is one of the following second mobile multimedia formats: digital video broadcasting-handheld (DVB-H) data, digital video broadcasting-satellite services to handhelds (DVB-SH) data, digital video broadcasting-handheld 2 (DVB-H2) data, China Multimedia Mobile Broadcasting (CMMB) data, or Advanced Television Systems Committee-Mobile/Handheld (ATSC-M/H) data.

41. The apparatus of claim 39, wherein the non-MediaFLO data is a DVB-H table or a plurality of tables.

42. The apparatus of claim 39, further comprising means for synchronizing to a GPS synchronous time that is used to generate the MediaFLO waveform, wherein the MediaFLO waveform does not completely fill each alternative superframe.

43. The apparatus of claim 40, further comprising means for constructing a second mobile multimedia format to complete the allocation of the MediaFLO waveform.

44. The apparatus of claim 40, further comprising means for operating the balance of the MediaFLO waveform with MediaFLO data for MediaFLO services.

45. The apparatus of claim 44, wherein the balance of the MediaFLO waveform operating MediaFLO services does not reference specific regions of time frequency space.

46. The apparatus of claim 45, wherein the specific regions of time frequency space that are not referenced in a MediaFLO system contain a second mobile multimedia format.

47. The apparatus of claim 44, wherein the balance of the MediaFLO waveform not operating MediaFLO services does not reference specific regions of time frequency space.

48. The apparatus of claim 44, wherein a portion of the MediaFLO waveform containing a second mobile multimedia format data does not reference regions of time that do not contain the second mobile multimedia signal format's data.

49. An apparatus for operating time division multiplexing (TDM) on segments of MediaFLO superframes comprising:
means for generating a MediaFLO OFDM waveform with a plurality of MediaFLO superframes;
means for multiplexing the MediaFLO OFDM waveform with non-MediaFLO data over the plurality of MediaFLO superframes for whole superframe durations; and
means for inserting MediaFLO data into at least one of the plurality of MediaFLO superframes.

50. The apparatus of claim 49, wherein the non-MediaFLO data is one of the following mobile multimedia formats: digital video broadcasting-handheld (DVB-H) data, digital video broadcasting-satellite services to handhelds (DVB-SH) data, digital video broadcasting-handheld 2 (DVB-H2) data, China Multimedia Mobile Broadcasting (CMMB) data, or Advanced Television Systems Committee-Mobile/Handheld (ATSC-M/H) data.

51. The apparatus of claim 50, wherein the whole superframe durations of the second mobile multimedia format are one second.

52. The apparatus of claim 49, further comprising means for identifying which of the plurality of MediaFLO superframes include the MediaFLO data.

53. The apparatus of claim 52, further comprising means for communicating the plurality of MediaFLO superframes that include the MediaFLO data to a MediaFLO receiver.

54. The apparatus of claim 50, further comprising means for identifying which of the plurality of MediaFLO superframes include a second mobile multimedia format data.

55. The apparatus of claim 54, further comprising means for communicating the plurality of MediaFLO superframes that include the second mobile multimedia format data to a MediaFLO receiver.

56. The apparatus of claim 50, wherein the balance of the MediaFLO waveform not operating MediaFLO services does not reference specific regions of time frequency space.

57. The apparatus of claim 50, wherein a portion of the MediaFLO waveform containing a second mobile multimedia format's data does not reference regions of time that do not contain the second mobile multimedia format's data.

58. A computer-readable medium storing a computer program, wherein execution of the computer program is for:
generating a MediaFLO OFDM waveform with at least one MediaFLO superframe;
allocating a MediaFLO local multiplex time segment in the at least one MediaFLO superframe for non-MediaFLO data; and
inserting the non-MediaFLO data into the MediaFLO local multiplex time segment.

59. The computer-readable medium of claim 58, wherein the non-MediaFLO data is one of the following second mobile multimedia formats: digital video broadcasting-handheld (DVB-H) data, digital video broadcasting-satellite services to handhelds (DVB-SH) data, digital video broadcasting-handheld 2 (DVB-H2) data, China Multimedia Mobile Broadcasting (CMMB) data, or Advanced Television Systems Committee-Mobile/Handheld (ATSC-M/H) data.

60. The computer-readable medium of claim 58, wherein the non-MediaFLO data is a DVB-H table or a plurality of tables.

61. The computer-readable medium of claim 58, wherein execution of the computer program is also for synchronizing to a GPS synchronous time that is used to generate the MediaFLO waveform, wherein the MediaFLO waveform does not completely fill each alternative superframe.

62. The computer-readable medium of claim 59, wherein execution of the computer program is also for constructing a second mobile multimedia format to complete the allocation of the MediaFLO waveform.

63. The computer-readable medium of claim 59, wherein execution of the computer program is also for operating the balance of the MediaFLO waveform with MediaFLO data for MediaFLO services.

64. The computer-readable medium of claim 63, wherein the balance of the MediaFLO waveform operating MediaFLO services does not reference specific regions of time frequency space.

65. The computer-readable medium of claim 64, wherein the specific regions of time frequency space that are not referenced in a MediaFLO system contain a second mobile multimedia format.

66. The computer-readable medium of claim 63, wherein the balance of the MediaFLO waveform not operating MediaFLO services does not reference specific regions of time frequency space.

67. The computer-readable medium of claim 63, wherein a portion of the MediaFLO waveform containing a second mobile multimedia format data does not reference regions of time that do not contain the second mobile multimedia signal format's data.

68. A computer-readable medium storing a computer program, wherein execution of the computer program is for:
generating a MediaFLO OFDM waveform with a plurality of MediaFLO superframes;
multiplexing the MediaFLO OFDM waveform with non-MediaFLO data over the plurality of MediaFLO superframes for whole superframe durations; and
inserting MediaFLO data into at least one of the plurality of MediaFLO superframes.

69. The computer-readable medium of claim 68, wherein the non-MediaFLO data is one of the following mobile multimedia formats: digital video broadcasting-handheld (DVB-H) data, digital video broadcasting-satellite services to handhelds (DVB-SH) data, digital video broadcasting-handheld 2 (DVB-H2) data, China Multimedia Mobile Broadcasting (CMMB) data, or Advanced Television Systems Committee-Mobile/Handheld (ATSC-M/H) data.

70. The computer-readable medium of claim 69, wherein the whole superframe durations of the second mobile multimedia format are one second.

71. The computer-readable medium of claim 68, wherein execution of the computer program is also for identifying which of the plurality of MediaFLO superframes include the MediaFLO data.

72. The computer-readable medium of claim 71, wherein execution of the computer program is also for communicating the plurality of MediaFLO superframes that include the MediaFLO data to a MediaFLO receiver.

73. The computer-readable medium of claim 69, wherein execution of the computer program is also for identifying which of the plurality of MediaFLO superframes include a second mobile multimedia format data.

74. The computer-readable medium of claim 73, wherein execution of the computer program is also for communicating the plurality of MediaFLO superframes that include the second mobile multimedia format data to a MediaFLO receiver.

75. The computer-readable medium of claim 69, wherein the balance of the MediaFLO waveform not operating MediaFLO services does not reference specific regions of time frequency space.

76. The computer-readable medium of claim 69, wherein a portion of the MediaFLO waveform containing a second mobile multimedia format's data does not reference regions of time that do not contain the second mobile multimedia format's data.
